(19) United States
(12) Patent Application Publication
(10) Pub. No.: US 2026/0290662 A1
(43) Pub. Date: Sep. 24, 2026

(54) METHOD FOR PRODUCING MAGNETIC PARTICLES, MAGNETIC PARTICLES, AND PERMANENT MAGNET USING SAME

(71) Applicant: AGC Inc., Tokyo (JP)

(72) Inventors: Koji NAITO, Tokyo (JP); Yasunari ISHIKAWA, Tokyo (JP); Keishi TSUKIYAMA, Tokyo (JP)

(73) Assignee: AGC Inc., Tokyo (JP)

(21) Appl. No.: 19/672,901

(22) Filed: May 11, 2026

Related U.S. Application Data
(63) Continuation of application No. PCT/JP2024/039315, filed on Nov. 5, 2024.

(30) Foreign Application Priority Data
Nov. 14, 2023 (JP) 2023-193429

(51) Int. Cl. H01F 1/047; H01F 7/02; H01F 41/02

(52) U.S. Cl. CPC H01F 1/047; H01F 7/02; H01F 41/0266

(57) ABSTRACT

A method for producing magnetic particles containing a manganese-aluminum alloy, the method including: mixing manganese particles, an aluminum source, an activator containing a halide, and an anti-sintering agent to obtain a mixed powder, in which the manganese particles have a maximum particle diameter of 50 μm or less, and the anti-sintering agent has a maximum particle diameter of 0.0002 times or more and 3 times or less the maximum particle diameter of the manganese particles; heating the mixed powder to a temperature in a range of 1,000° C. to 1,235° C. to perform a calorizing treatment on the manganese particles to obtain a treated mixture that comprises particles containing a manganese-aluminum alloy, in which the manganese-aluminum alloy has a ratio (Al/Mn) of aluminum to manganese in a range of 25/75 to 35/65 in mass ratio; and collecting the particles containing a manganese-aluminum alloy from the treated mixture.

### CROSS-REFERENCE TO RELATED APPLICATIONS

This is a continuation of International Application No. PCT/JP2024/039315 filed on Nov. 5, 2024, and claims priority from Japanese Patent Application No. 2023-193429 filed on Nov. 14, 2023, the entire contents of which are incorporated herein by reference.

### TECHNICAL FIELD

The present invention relates to a method for producing magnetic particles and magnetic particles.

### BACKGROUND ART

It has traditionally been known that magnetic particles containing a manganese-aluminum alloy containing a τ phase can be used as a magnetic material.
Patent Literature 1: JP2019-44265A

### SUMMARY OF INVENTION

In general, magnetic particles containing a manganese-aluminum alloy can be produced through
(1) formation of a powder by using a melt spraying method or the like (gas atomization treatment) and
(2) a heat treatment on the powder.

In the treatment in (1), a powder mainly containing an ε phase, which is not a ferromagnetic phase, is formed. Therefore, it is necessary to convert the ε phase into the τ phase, which is a ferromagnetic phase, by the heat treatment (aging treatment) in (2).

However, such a production process is complicated, and there is a need for a method that produces magnetic particles containing a manganese-aluminum alloy containing the τ phase with a simpler method.

The present invention has been made in view of such a background, and it is an object of the present invention to provide a method that can produce magnetic particles containing a manganese-aluminum alloy in a simpler manner. It is also an object of the present invention to provide magnetic particles containing a manganese-aluminum alloy obtained by such a characteristic process.

The present invention provides a method for producing magnetic particles containing a manganese-aluminum alloy, the method including:
mixing manganese particles, an aluminum source, an activator containing a halide, and an anti-sintering agent to obtain a mixed powder, in which the manganese particles have a maximum particle diameter of 50 μm or less, and the anti-sintering agent has a maximum particle diameter of 0.0002 times or more and 3 times or less the maximum particle diameter of the manganese particles;
heating the mixed powder to a temperature in a range of 1,000° C. to 1,235° C. to perform a calorizing treatment on the manganese particles to obtain a treated mixture that includes particles containing a manganese-aluminum alloy, in which the manganese-aluminum alloy has a ratio (Al/Mn) of aluminum to manganese in a range of 25/75 to 35/65 in mass ratio; and
collecting the particles containing a manganese-aluminum alloy from the treated mixture.

The present invention provides magnetic particles including:
a manganese-aluminum alloy; and
alumina, in which
the alumina contained in the magnetic particles has an existence proportion in a range of 0.1 mass % to 30 mass %,
the manganese-aluminum alloy contained in the magnetic particles has an existence proportion in a range of 70 mass % to 99 mass %,
the manganese-aluminum alloy contains a τ phase,
the τ phase has an existence proportion in a range of 10 mass % to 99 mass % relative to the manganese-aluminum alloy, and
the magnetic particles have a maximum particle diameter of 50 μm or less and a coercive force of 1,000 Oe or more.

According to the present invention, it is possible to provide a method that can produce magnetic particles containing a manganese-aluminum alloy in a simper manner. In addition, according to the present invention, it is possible to provide magnetic particles containing a manganese-aluminum alloy obtained by such a characteristic process.

### BRIEF DESCRIPTION OF DRAWINGS

FIG. 1 is a chart schematically showing an example of a flow of a method for producing magnetic particles according to an embodiment of the present invention.

FIG. 2 is a photograph showing a form of magnetic particles according to an embodiment of the present invention.

FIG. 3 is a photograph showing a form of magnetic particles according to another embodiment of the present invention.

FIG. 4 is a photograph showing a form of magnetic particles according to a comparative example.

FIG. 5 is a graph showing particle size distributions measured for magnetic particles according to an embodiment of the present invention and magnetic particles according to the comparative example.

### DESCRIPTION OF EMBODIMENTS

Hereinafter, an embodiment of the present invention will be described.

As described above, in a method for producing magnetic particles containing a manganese-aluminum alloy in the related art, a gas atomization treatment and a subsequent aging treatment are required, and a method for producing magnetic particles containing a manganese-aluminum alloy containing a τ phase with a simpler method is required.

Under such circumstances, the inventors of the present invention have found that there is a possibility that the magnetic particles containing manganese-aluminum alloy can be produced by a single treatment by adopting a calorizing treatment.

The calorizing treatment is a technique of causing aluminum to diffuse and permeate a treatment target from a surface thereof to an interior thereof at a high temperature. When manganese particles are used as the treatment target, aluminum can be caused to permeate the manganese particles during the calorizing treatment to form a manganese-aluminum alloy. Therefore, by setting a ratio between manganese and aluminum in the reaction system and the temperature within a predetermined range, there is a possibility that a manganese-aluminum alloy containing a τ phase can be formed after the calorizing treatment.

It is considered that magnetic particles containing a manganese-aluminum alloy can be produced by such a calorizing treatment in a simpler process than in the related art.

However, when the calorizing treatment is merely applied to a manganese alloy without sufficient consideration, reduction of an oxide and oxidation of aluminum may occur in the reaction system, and a solid phase contact reaction (thermite reaction) accompanied by large heat generation may occur. When such a thermite reaction occurs, the treatment environment becomes an extremely high temperature, and there is a concern that the particles firmly adhere to each other in a mixture (hereinafter, referred to as a “treated mixture”) after the treatment.

Note that, in order to cope with this problem, it is considered that an anti-sintering agent is used during the calorizing treatment, and the calorizing treatment is performed on the manganese particles in a gap formed between the anti-sintering agents.

In this case, since the gap plays a role of providing “small compartment” for the reaction separated from each other, even when the thermite reaction occurs in the reaction system, a possibility that the manganese particles adhere to the anti-sintering agent or the like can be reduced.

However, in this method, when a dimension of the gap is too large, there is a problem that a particle diameter of the obtained magnetic particles containing a manganese-aluminum alloy increases. In the case of magnetic particles having a large particle diameter, there is a possibility that good magnetic properties cannot be obtained.

The inventors of the present invention have also conducted intensive research and development on such a newly occurring problem. Then, the present inventors have found that the above problems can be solved by appropriately controlling particle diameters of the anti-sintering agent and the manganese particles.

That is, an embodiment of the present invention provides a method for producing magnetic particles containing a manganese-aluminum alloy, the method including:
mixing manganese particles, an aluminum source, an activator containing a halide, and an anti-sintering agent to obtain a mixed powder, in which the manganese particles have a maximum particle diameter of 50 μm or less, and the anti-sintering agent has a maximum particle diameter of 0.0002 times or more and 3 times or less the maximum particle diameter of the manganese particles;
heating the mixed powder to a temperature in a range of 1,000° C. to 1,235° C. to perform a calorizing treatment on the manganese particles to obtain a treated mixture that includes particles containing a manganese-aluminum alloy, in which the manganese-aluminum alloy has a ratio (Al/Mn) of aluminum to manganese in a range of 25/75 to 35/65 in mass ratio; and
collecting the particles containing a manganese-aluminum alloy from the treated mixture.

In the embodiment of the present invention, magnetic particles containing a manganese-aluminum alloy containing a τ phase are produced by using the calorizing treatment described above.

In the embodiment of the present invention, unlike a gas atomization method in the related art, the magnetic particles containing a manganese-aluminum alloy containing a T phase can be produced directly after the treatment. Therefore, the magnetic particles containing a manganese-aluminum alloy can be produced by a relatively simple process.

In the embodiment of the present invention, particles having a maximum particle diameter (hereinafter referred to as D₍₁₎ₘₐₓ) of 50 μm or less are used as the manganese particles, and particles having a maximum particle diameter (hereinafter referred to as D₍₂₎ₘₐₓ) of 0.0002×D₍₁₎ₘₐₓ or more and 3×D₍₁₎ₘₐₓ or less are used as the anti-sintering agent.

Note that, the maximum particle diameter D₍₂₎ₘₐₓ of the anti-sintering agent is 3 times or less, preferably 1 time or less, and more preferably 0.225 times or less the maximum particle diameter D₍₁₎ₘₐₓ of the manganese particles.

When the particle diameter of each material is selected in this manner, during the calorizing treatment, the calorizing treatment can be performed in the gap formed between the anti-sintering agents. Therefore, even when the thermite reaction occurs in the reaction system, the possibility that the manganese particles adhere to the anti-sintering agent or the like can be remarkably reduced.

In addition, when the particle diameter relationship as described above is selected, the dimension of the gap is relatively small, and magnetic particles containing a manganese-aluminum alloy having a relatively small particle diameter can be obtained. As a result, it is possible to obtain magnetic particles containing a manganese-aluminum alloy having relatively good magnetic properties such as a high coercive force.

For example, in the embodiment of the present invention, magnetic particles containing a manganese-aluminum alloy having a maximum particle diameter of 50 μm or less can be obtained immediately after collection.

### Method for Producing Magnetic Particles According to Embodiment of Present Invention

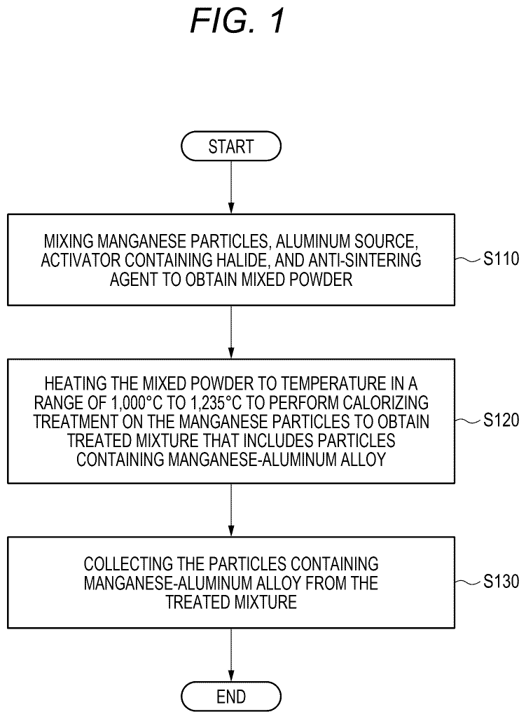

Next, a method for producing magnetic particles according to an embodiment of the present invention will be described in more detail with reference to FIG. 1.

FIG. 1 schematically shows an example of a flow of the method for producing magnetic particles according to the embodiment of the present invention.

As shown in FIG. 1, the method for producing magnetic particles according to the embodiment of the present invention (hereinafter, referred to as a “first production method”) includes:
mixing manganese particles, an aluminum source, an activator containing a halide, and an anti-sintering agent to obtain a mixed powder (step S110);
heating the mixed powder to a temperature in a range of 1,000° C. to 1,235° C. to perform a calorizing treatment on the manganese particles to obtain a treated mixture that includes particles containing a manganese-aluminum alloy (step S120); and
collecting the particles containing a manganese-aluminum alloy from the treated mixture (step S130).

Hereinafter, each of the steps will be described in more detail.

### (Step S110)

First, a mixed powder is prepared.

The mixed powder includes manganese particles, an anti-sintering agent, an aluminum source, and an activator. Hereinafter, each component will be described.

### (Manganese Particles)

The maximum particle diameter D₍₁₎ₘₐₓ of the manganese particles is selected to be 50 μm or less. The maximum particle diameter D₍₁₎ₘₐₓ of the manganese particles is, for example, in a range of 0.01 μm to 50 μm, preferably in a range of 0.01 μm to 25 μm, and more preferably in a range of 0.01 μm to 10 μm.

In addition, an average particle diameter (hereinafter referred to as “D₍₁₎ₐᵥₑ”) of the manganese particles may be, for example, in a range of 0.01 μm to 50 μm.

Note that, in the present description, the “maximum particle diameter” is grasped as a maximum length of a straight line passing through a center of gravity of the particle. Therefore, when the particles are spherical, the “maximum particle diameter” corresponds to a diameter.

In addition, in the present invention, the “average particle diameter” is measured by the method specified in JIS Z 8801.

That is, sieves having different mesh sizes are stacked over some stages in an ascending order of the mesh size, and the measurement-target particles are vibrated at a constant amplitude for a certain time to sort the particles. Next, the mass of the particles remaining on each sieve is measured, and a particle-mass-based particle size distribution is graphed. The particle diameter corresponding to a cumulative value of 50% in the obtained particle size distribution is defined as the “average particle diameter”.

### (Anti-Sintering Agent)

The maximum particle diameter D₍₂₎ₘₐₓ of the anti-sintering agent is selected to be 0.0002 times or more and 3 times or less the maximum particle diameter D₍₁₎ₘₐₓ of the manganese particles.

The maximum particle diameter D₍₂₎ₘₐₓ of the anti-sintering agent may be, for example, 2×D₍₁₎ₘₐₓ or less, or 1×D₍₁₎ₘₐₓ or less.

The maximum particle diameter D₍₂₎ₘₐₓ of the anti-sintering agent is preferably 1 time or less, and more preferably 0.225 times or less the maximum particle diameter D₍₁₎ₘₐₓ of the manganese particles.

Alternatively, the maximum particle diameter D₍₂₎ₘₐₓ of the anti-sintering agent may be 0.2 times or more and 2 times or less the maximum particle diameter D₍₁₎ₘₐₓ of the manganese particles.

Specifically, the maximum particle diameter D₍₂₎ₘₐₓ of the anti-sintering agent may be 150 μm or less.

The anti-sintering agent may include at least one selected from the group consisting of alumina, kaolin, calcia, zirconia, magnesia, and silicon oxide.

For example, the anti-sintering agent may have at least one shape selected from the group consisting of a spherical shape, a triangular pyramidal shape, a triangular prismatic shape, a tetrahedral shape, a conical shape, and a cylindrical shape. Note that, when particles of the anti-sintering agent have a shape other than a spherical shape, the particle diameter of the anti-sintering agent is a maximum dimension of the particles.

An average particle diameter (hereinafter referred to as “D₍₂₎ₐᵥₑ”) of the anti-sintering agent may be, for example, in a range of 0.01 μm to 150 μm.

In addition, the anti-sintering agent may have two or more particle size distribution peaks when the particle size distribution is measured. For example, the anti-sintering agent may include three kinds of particles: large particles having a large particle diameter, medium particles having a medium particle diameter, and small particles having a small particle diameter. In this case, three particle size distribution peaks appear in the particle size distribution.

When the anti-sintering agent has a plurality of particle size distribution peaks, the dimension of the gap can be more precisely controlled.

### (Aluminum Source)

The aluminum source may be aluminum metal particles or aluminum alloy particles.

An average particle diameter (hereinafter, represented by D₍₃₎ₐᵥₑ) of the aluminum source is, for example, in a range of 0.1 μm to 300 μm. When the average particle diameter D₍₃₎ₐᵥₑ of the aluminum source is 0.1 μm or less, the aluminum source easily enters the gap between the anti-sintering agents, and a heat treatment time can be shortened.

The average particle diameter D₍₃₎ₐᵥₑ of the aluminum source is preferably in a range of 0.01 μm to 75 μm, and more preferably in a range of 0.01 μm to 10 μm.

### (Activator)

The activator has a function for forming a vapor of a metal halide during the calorizing treatment on the manganese particles, thereby promoting the calorizing treatment.

The activator includes, for example, at least one selected from the group consisting of ammonium chloride, aluminum chloride, and aluminum fluoride. The activator is added, for example, in a range of 0.1 mass % to 10 mass % relative to a total mass of the manganese particles and the aluminum source.

### (Mixed Powder)

The mixed powder is prepared by mixing the above components.

An amount of the manganese particles contained in an entirety of the mixed powder is, for example, in a range of 3 mass % to 45 mass %. In addition, an amount of the aluminum source contained in the entirety of the mixed powder is, for example, in a range of 1 mass % to 15 mass %. In addition, an amount of the anti-sintering agent contained in the entirety of the mixed powder can be appropriately adjusted based on the amount of the manganese particles and the amount of the aluminum source, and is, for example, in a range of 40 mass % to 96 mass %.

In the mixed powder, the aluminum source is added such that a mass ratio (Al/Mn) of aluminum to manganese contained in manganese-aluminum alloy particles to be produced is in a range of 25/75 to 35/65.

For example, a mass ratio P represented by the following equation may be in a range of 65 to 75:

$$Ratio P ( \% ) = \{ X / ( X + Y ) \} \times 100$$

Here, X is the mass of the manganese particles contained in the mixed powder, and Y is the mass of aluminum contained in the aluminum source contained in the mixed powder.

After the mixed powder is prepared, a press treatment may be performed on the mixed powder as necessary.

By performing the press treatment, the mixed powder is pulverized, and the anti-sintering agent and the manganese particles in the mixed powder are refined. Therefore, finer manganese-aluminum alloy particles can be obtained after the subsequent step S130.

The press treatment may be performed using, for example, a press machine. For example, a pressure between 10 MPa and 1,000 MPa may be applied to the mixed powder.

A vibration treatment may be performed on the mixed powder in addition to the press treatment, or alternatively, without performing the press treatment. By performing the vibration treatment, the mixed powder can be more densely packed, and a smaller gap can be formed.

### (Step S120)

Next, the mixed powder prepared in the step S110 is subjected to a heat treatment. Therefore, the mixed powder may be packed in a reaction vessel.

By heating the reaction vessel, the calorizing treatment is performed on the manganese particles. That is, aluminum generated from the aluminum source diffuses and permeates the manganese particles, to form magnetic particles containing a manganese-aluminum alloy.

When the reaction vessel is heated, a large amount of heat is generated due to a thermite reaction between the mixed powder particles. This is because aluminum reacts with a small amount of oxygen contained in the manganese particles.

However, in the first production method, as described above, by using the gap formed between the anti-sintering agents, the calorizing treatment is performed on the manganese particles in the gap. Therefore, in the first production method, the problem that the manganese particles adhere to the anti-sintering agent or the like can be remarkably suppressed.

In the first production method, the maximum particle diameter D₍₁₎ₘₐₓ of the manganese particles and the maximum particle diameter D₍₂₎ₘₐₓ of the anti-sintering agent are selected as described above. Accordingly, the dimension of the gap is optimized, and magnetic particles containing a manganese-aluminum alloy having a small particle diameter can be formed.

Here, a volume ratio of the anti-sintering agent relative to a volume of the reaction vessel is preferably in a range of 10% to 74%. In addition, a volume ratio of the mixed powder relative to the volume of the reaction vessel is preferably in a range of 50% to 99%.

An treatment atmosphere during the calorizing treatment needs only to be an atmosphere containing no oxygen, and is, for example, an argon gas atmosphere.

The treatment temperature is in a range of 1,000° C. to 1,235° C., preferably in a range of 1,150° C. to 1,230° C., and more preferably in a range of 1,190° C. to 1,225° C. When the treatment temperature is low, an amount of the τ phase to be formed is low, and when the treatment temperature is too high, aggregation into a lumpy state occurs.

A retention time at a maximum temperature is, for example, 0.5 hours or longer, preferably 5 hours or longer, and more preferably 10 hours or longer.

Cooling after the treatment may be cooling in a furnace, and a cooling rate may be controlled. The cooling rate may be, for example, in a range of 0.01° C./min to 100° C./min. However, the temperature may be temporarily retained at a predetermined temperature during the cooling.

A cooling temperature may be controlled stepwise.

A pressure in the reaction vessel is, for example, in a range of 1 atm to 30 atm. The pressure is preferably 1.5 atm or more, more preferably 2 atm or more, and still more preferably 3 atm or more.

In addition, the pressure is preferably 30 atm or less, more preferably 20 atm or less, and still more preferably 10 atm or less.

The treatment pressure may be increased by airtight sealing of the reaction vessel used in the reaction. In this case, for example, the pressure in the reaction vessel may be increased through gasification of the activator. Such an activator may include at least one selected from the group consisting of ammonium chloride, aluminum chloride, and aluminum fluoride.

Alternatively, the pressure in the reaction vessel may be increased by filling the reaction vessel with an additional gas. In this case, the additional gas may be selected from an inert gas, hydrogen, or chlorine.

Note that, the temperature and the pressure may be independently controlled.

Through the step S120, a treated mixture is formed.

### (Step S130)

Next, the magnetic particles containing a manganese-aluminum alloy are separated and collected from the treated mixture formed in the step S120.

A collection method is not particularly limited, and for example, a magnetic separation method may be adopted.

The magnetic separation method is a method of selectively collecting particles having a magnetic phase by a magnetic force of a magnet or the like.

In the magnetic separation method, a non-magnetic material such as the anti-sintering agent is removed from the treated mixture by a magnetic force exerted only by a magnetic material, and magnetic particles containing a manganese-aluminum alloy can be separated and collected.

Note that, in the first production method, even when the dimension of the gap is controlled as described above, some of the magnetic particles containing a manganese-aluminum alloy may adhere to each other.

In this case, the magnetic particles containing a manganese-aluminum alloy may be separated and collected from the treated mixture by a crushing treatment using a ball mill, a jaw crusher, or the like.

In the first production method, with the above steps, magnetic particles containing a manganese-aluminum alloy can be produced.

Note that, the first production method has a feature that a small amount of alumina is contained in the obtained magnetic particles.

This is considered to be because a part of aluminum as a constituent of the manganese-aluminum alloy is oxidized during the calorizing treatment.

An amount of alumina contained in the produced magnetic particles is in a range of 0.1 mass % to 30 mass %, and may be in a range of 1 mass % to 10 mass % relative to a weight of the magnetic particles.

In addition, an amount of the manganese-aluminum alloy contained in the magnetic particles is in a range of 70 mass % to 99 mass %, and may be in a range of 86 mass % to 98 mass %.

In addition, the magnetic particles may contain a compound obtained by combining at least some of Mn, Al, O, and C as a compound other than those described above, or a compound derived from impurities.

In addition, in the manganese-aluminum alloy contained in the magnetic particles, the τ phase may be contained in a range of 10 mass % to 99 mass % relative to the manganese-aluminum alloy. The content of the τ phase is, for example, preferably 30 mass %, and more preferably 50 mass % or more relative to the manganese-aluminum alloy.

In addition to the τ phase, the manganese-aluminum alloy contained in the magnetic particles may contain at least one selected from the group consisting of an ε phase, a β phase, and a γ phase.

Note that, in the present description, the τ phase means MnAl having a tetragonal structure. The ε phase means MnAl having a hexagonal structure. The β phase means Mn₃Al₂ having a cubic structure. The γ phase means Mn₅Al₈ having a rhombohedral structure.

However, it is preferable that the ε phase exists in an amount of 10 mass % or less relative to an entirety of the manganese-aluminum alloy.

### Magnetic Particles According to Embodiment of Present Invention

Next, magnetic particles according to an embodiment of the present invention will be described.

An embodiment of the present invention provides magnetic particles including:
a manganese-aluminum alloy; and
alumina, in which
the alumina contained in the magnetic particles has an existence proportion in a range of 0.1 mass % to 30 mass %,
the manganese-aluminum alloy contained in the magnetic particles has an existence proportion in a range of 70 mass % to 99 mass %,
the manganese-aluminum alloy contains a τ phase,
the τ phase has an existence proportion in a range of 10 mass % to 99 mass % relative to the manganese-aluminum alloy, and
the magnetic particles have a maximum particle diameter of 50 μm or less and a coercive force of 1,000 Oe (oersted) or more.

The magnetic particles in the embodiment of the present invention have a maximum particle diameter (hereinafter, represented by D₍ₛ₎ₘₐₓ) of 50 μm or less. The maximum particle diameter D₍ₛ₎ₘₐₓ may be 40 μm or less.

The magnetic particles according to the embodiment of the present invention are produced by a calorizing treatment such as that in the first production method described above. In the calorizing treatment, a small amount of alumina is formed when aluminum permeates and alloys with the manganese particles.

Therefore, the magnetic particles according to the embodiment of the present invention have a feature of containing alumina in addition to the manganese-aluminum alloy.

In the embodiment of the present invention, an existence proportion of alumina contained in the magnetic particles is preferably low. A lower limit thereof is 0.1 mass % or more, and may be 1 mass % or more, 2 mass % or more, or 2.5 mass % or more. An upper limit thereof is preferably 15 mass % or less, and more preferably 10 mass % or less. When the existence proportion of alumina decreases, an existence proportion of a non-magnetic phase decreases, and an existence proportion of the τ phase, which is a ferromagnetic phase, can be increased.

Note that, in general, alumina tends to be unevenly distributed on an outermost surface of the magnetic particles. However, alumina may also exist inside the magnetic particles.

The existence proportion of the manganese-aluminum alloy contained in the magnetic particles according to the embodiment of the present invention is in a range of 70 mass % to 99 mass %, and preferably in a range of 80 mass % to 99 mass %.

In the embodiment of the present invention, the existence proportion of the τ phase is in a range of 10 mass % to 99 mass %, for example, preferably 30 mass % or more, and 40 mass % or more.

The magnetic particles according to the embodiment of the present invention have a coercive force of 1,000 Oe or more. The coercive force may be, for example, 1,100 Oe or more, and 1,150 Oe or more.

In addition, the existence proportion of the τ phase relative to the manganese-aluminum alloy in the magnetic particles according to the embodiment of the present invention is in a range of 10 mass % to 99 mass %, preferably 30 mass % or more, and more preferably 40 mass % or more.

In addition, in the magnetic particles according to the embodiment of the present invention, the manganese-aluminum alloy may contain at least one selected from the group consisting of an ε phase, a β phase, and a γ phase in addition to the τ phase. However, the amount of the ε phase contained in the manganese-aluminum alloy is preferably 10 mass % or less.

In addition, the manganese-aluminum alloy contained in the magnetic particles according to the embodiment of the present invention may contain 65 mass % to 75 mass % of manganese and 25 mass % to 35 mass % of aluminum.

The magnetic particles according to the embodiment of the present invention have a high coercive force of 1,000 Oe or more. Therefore, the magnetic particles according to the embodiment of the present invention can be applied to a permanent magnet.

For example, it is possible to produce a MnAl-based permanent magnet by molding and sintering a powder containing the magnetic particles according to the embodiment of the present invention. The MnAl-based permanent magnet may have any shape. For example, the MnAl-based permanent magnet may have a rectangular parallelepiped shape, an arch shape, a C shape, or the like.

Hereinafter, a method for producing the MnAl-based permanent magnet using the magnetic particles according to the embodiment of the present invention will be described. However, the method for producing a MnAl-based permanent magnet is not limited to this, and other publicly-known methods may be used. For example, the MnAl-based permanent magnet according to the present embodiment may be produced by hot working.

In a molding step, the powder containing the magnetic particles according to the embodiment of the present invention is molded into a target shape. The molding may be performed by any method. In one embodiment, the magnetic particles are packed in a mold and pressurized. The obtained molded body is sintered in a vacuum or an inert gas atmosphere to obtain a sintered body.

Here, dry molding in which the magnetic particles are directly molded is shown. However, wet molding in which a slurry obtained by dispersing the magnetic particles in a solvent such as oil is molded can also be used. A shape of the molded body obtained by molding the magnetic particles can be any shape.

The MnAl-based permanent magnet obtained by the above method is to be a MnAl-based permanent magnet product through magnetization. The MnAl-based permanent magnet according to the embodiment of the present invention is suitably used in applications such as a motor and a power generator.

Note that, the method for producing the permanent magnet is not particularly limited as long as the effect of the present invention is not impaired, and various hitherto publicly known production methods can be used.

### EXAMPLES

Hereinafter, Examples of the present invention will be described. In the following description, Examples 1 to 7 are Inventive Examples. Examples 11 and 12 are Comparative Examples.

### Example 1

A powder was prepared by the following method.

First, 68 g of manganese particles (maximum particle diameter: 50 μm, average particle diameter: 25 μm) and 32 g of aluminum particles (average particle diameter: 75 μm) as an aluminum source were thoroughly mixed together with 300 ml of ethanol by ball milling (with 10 mm-diameter Monomaron balls), to obtain a first powder.

Next, ammonium chloride particles (0.4 mass %) as an activator and alumina particles (75.0 mass %) (maximum particle diameter: 100 μm, average particle diameter: 75 μm) as an anti-sintering agent were added to the first powder (24.6 mass %), and then these particles were thoroughly mixed to prepare a mixed powder.

In the mixed powder, a ratio (Y/(X+Y)) of a content Y of the aluminum particles to a content X of the manganese particles and the content Y of the aluminum particles was 32 mass % in mass ratio. In addition, a value of the maximum particle diameter of the alumina particles to the maximum particle diameter of the manganese particles, that is, a ratio D₍₂₎ₘₐₓ/D₍₁₎ₘₐₓ, was 2.00.

Next, the mixed powder was packed in a heat-resistant vessel having a cap. According to calculation, a packing ratio of the alumina particles was 74% by volume. In addition, the manganese particles, the aluminum particles, and the ammonium chloride particles were packed so as to occupy 80% of the remaining voids (26%).

Next, the interior of the heat-resistant vessel was depressurized and then purged with an argon atmosphere, and then the heat-resistant vessel was heated to 1,215° C. After being retained at 1,215° C. for 10 hours, the heat-resistant vessel was cooled in a furnace.

Thereafter, the treated mixture was taken out from the heat-resistant vessel, and the magnetic particles were separated and collected by a magnetic separation method. Accordingly, a powder containing magnetic particles was obtained.

### Examples 2 to 7

Each powder was prepared by the same method as in Example 1. However, in Examples 2 to 7, the dimensions and the like of each particle contained in the mixed powder were changed from those in Example 1.

In addition, in Example 7, a press treatment was performed on the mixed powder before the calorizing treatment. The press treatment was performed by packing the mixed powder into a mold and pressurizing the mixed powder at 200 MPa using a hydraulic press machine.

### Example 11

A powder was prepared by the following method.

First, 350 g of manganese particles (maximum particle diameter: 75 μm) and 157.5 g of aluminum particles (200 mesh) were thoroughly mixed to prepare a mixed powder.

In the mixed powder, a ratio (Y/(X+Y)) of a content Y of the aluminum particles to a content X of the manganese particles and the content Y of the aluminum particles was 31 mass % in mass ratio.

Next, the mixed powder was charged into a crucible, set in a gas atomization apparatus, and heated to 1,550° C. by a heating coil. The mixed powder was in a state of being thoroughly melted.

Thereafter, the molten metal was dropped downward from a molten metal outlet having an orifice diameter of 2 mm provided in a lower portion of the crucible. In addition, an argon gas was sprayed onto the molten metal being dropped at a spraying pressure of 5 MPa. The molten metal formed fine droplets, and was rapidly solidified while falling down a tower in the gas atomization apparatus.

Accordingly, a powder containing spherical particles was prepared.

### Example 12

A powder was prepared by the same method as in Example 1. However, in Example 12, the dimensions and the like of each particle contained in the mixed powder were changed from those in Example 1.

Table 1 below summarizes specifications of the mixed powder used in the production of the powder in each example.

TABLE 1

| | Mixed powder | | | | | |
|---|---|---|---|---|---|---|
| | Mn particles | | | Anti-sintering agent | | |
| | | Maxi- | Aver- | | Maxi- | Aver- |
| | | mum | age | | mum | age |
| | | particle | particle | | particle | particle |
| | Content | diameter | diameter | | diameter | diameter |
| Ex- | X | D₍₁₎ₘₐₓ | D₍₁₎ₐᵥₑ | Content | D₍₂₎ₘₐₓ | D₍₂₎ₐᵥₑ |
| ample | (mass %) | (μm) | (μm) | (mass %) | (μm) | (μm) |
| 1 | 16.7 | 50 | 25 | 75.0 | 100 | 75 |
| 2 | 16.7 | 50 | 25 | 75.0 | 20 | 10 |
| 3 | 16.7 | 30 | 25 | 75.0 | 10 | 1 |
| 4 | 41.5 | 30 | 10 | 38.0 | 20 | 10 |
| 5 | 16.7 | 30 | 10 | 75.0 | 10 | 1 |
| 6 | 16.7 | 30 | 10 | 75.0 | 1 | 0.3 |
| 7 | 16.7 | 30 | 10 | 75.0 | 20 | 10 |
| 11 | | 75 | — | — | — | — |
| 12 | 16.7 | 300 | 150 | 75.0 | 100 | 75 |

| | Mixed powder | | | | |
|---|---|---|---|---|---|
| | Al particles | | | | |
| | | Average | | | |
| | | particle | | | |
| | Content | diameter | Activator | Ratio | Al ratio |
| Ex- | Y | D₍₃₎ₐᵥₑ | Content | D₍₂₎ₘₐₓ/ | Y/(X + Y) |
| ample | (mass %) | (μm) | (mass %) | D₍₁₎ₘₐₓ | (mass %) |
| 1 | 7.9 | 75 | 0.4 | 2.00 | 32 |
| 2 | 7.9 | 75 | 0.4 | 0.40 | 32 |
| 3 | 7.9 | 75 | 0.4 | 0.20 | 32 |
| 4 | 19.5 | 75 | 1.0 | 1.00 | 32 |
| 5 | 7.9 | 75 | 0.4 | 0.50 | 32 |
| 6 | 7.9 | 75 | 0.4 | 0.50 | 32 |
| 7 | 7.9 | 75 | 0.4 | 1.00 | 32 |
| 11 | | — | — | | 31 |
| 12 | 7.9 | 75 | 0.4 | 0.33 | 32 |

In addition, in Table 2 below, process conditions used for producing each powder are collectiively shown.

TABLE 2

| | Treatment conditions | | | |
|---|---|---|---|---|
| | Temperature | Pressure | Retention | |
| Example | (° C.) | (atm) | time (h) | Others |
| 1 | 1215 | 3.25 | 10 | |
| 2 | 1215 | 3.25 | 10 | |
| 3 | 1215 | 3.25 | 10 | |
| 4 | 1215 | 3.25 | 10 | |
| 5 | 1215 | 3.25 | 10 | |
| 6 | 1215 | 3.25 | 10 | |
| 7 | 1215 | 3.25 | 10 | Press treatment |
| | | | | before calorizing |
| 11 | 1550 | — | — | Gas atomization method |
| 12 | 1215 | 3.25 | 10 | |

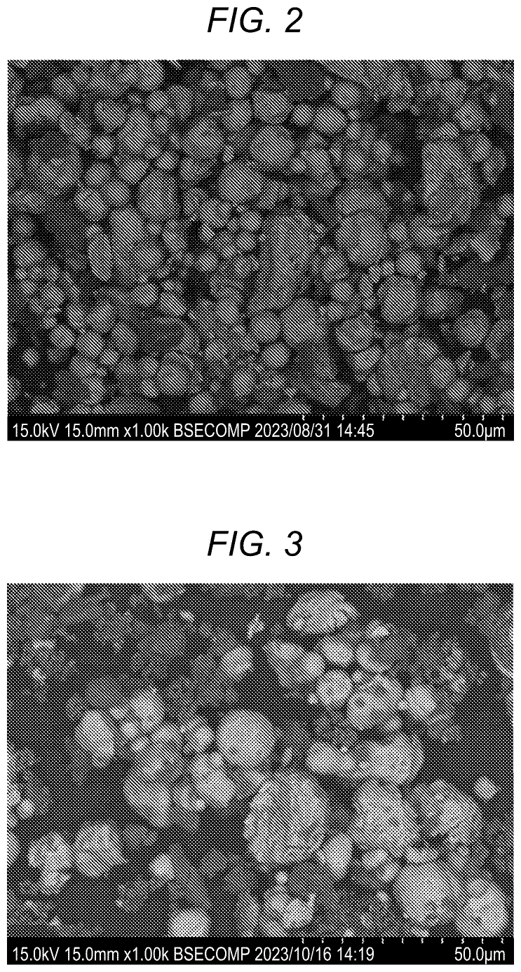

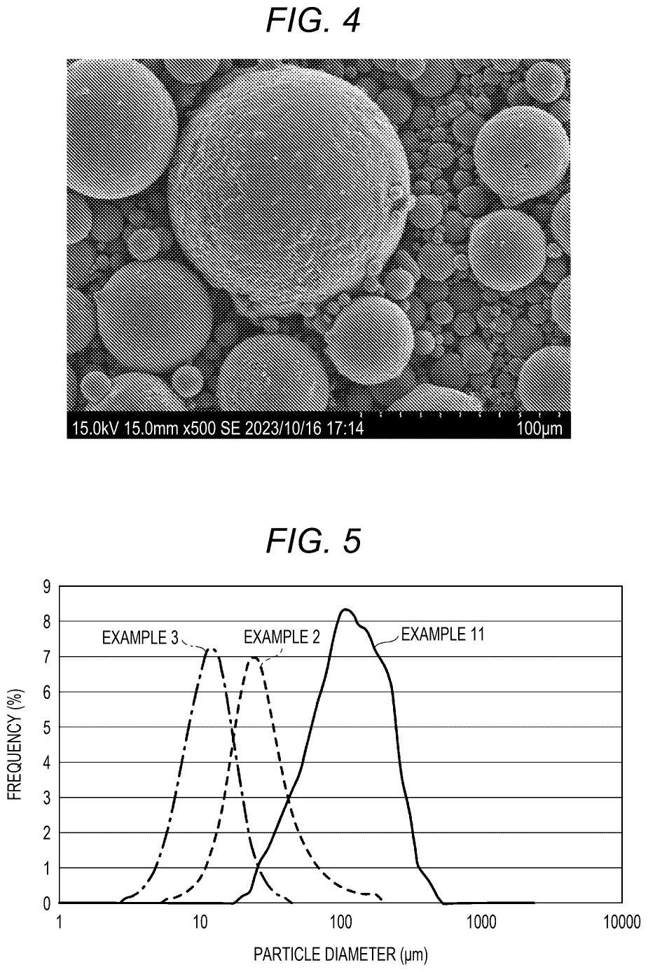

FIGS. 2 to 4 show examples of forms of the particles contained in the powder produced in Example 2, the powder produced in Example 3, and the powder produced in Example 11, respectively.

### Evaluation

The following evaluations were performed using each powder described above.

### (X-ray Diffraction Analysis)

An X-ray diffraction analysis of each powder was performed using an X-ray diffractometer (SmartLab manufactured by Rigaku Corporation). A mass fraction of each phase in the particles contained in the powder was determined based on the obtained diffraction pattern by a Rietveld analysis method.

The Rietveld analysis was performed using a program RIETAN-FP.

An extended pseudo-Voigt function of Toraya was used as a profile function. Fitting was performed such that a reliability factor Rwp (R-weighted pattern), which was a common criterion, would be <10% for the entire analysis range.

The analysis range was set to 2θ=10° to 120°.

From the results of the X-ray diffraction analysis, it is found that the powders produced in Examples 1 to 7 mainly contain a manganese-aluminum alloy and alumina.

Table 3 below collectively shows the calculated existence proportions of the phases in the powders produced in Examples 1 and 4.

TABLE 3

| | Existence proportion (%) | | | | | | |
|---|---|---|---|---|---|---|---|
| Example | τ phase | γ phase | β phase | ε phase | Al₂O₃ | Mn₄N | Total |
| 1 | 42 | 27 | 21 | N.D. | 10 | N.D. | 100 |
| 4 | 42 | 42 | 9 | N.D. | 7 | N.D. | 100 |

From Table 3, it is found that the powders produced in Examples 1 and 4 contain the τ phase and alumina. It is particularly found that the τ phase exists in an amount of 40 mass % or more and alumina exists in an amount of 5 mass % or more in these powders.

### (Measurement of Particle Size Distribution)

The particle size distribution of each powder produced in Examples 2, 3, and 11 was measured using a laser diffraction/scattering particle diameter distribution analyzer (manufactured by HORIBA, Ltd.).

FIG. 5 collectively shows the obtained results.

From FIG. 5, it is found that each of the powders produced in Examples 2 and 3 has a finer particle diameter than the powder in Example 11.

### (Measurement of Maximum Particle Diameter)

The maximum particle diameter D₍ₛ₎ₘₐₓ of the powder produced in each example was measured using a laser diffraction/scattering particle diameter distribution analyzer (manufactured by HORIBA, Ltd.).

### (Measurement of Coercive Force)

The coercive force of the powder produced in each example was measured using a vibrating sample magnetometer (VSM-C7-10A) (manufactured by Toei Industry Co., Ltd.).

Table 4 below collectively shows the values of the maximum particle diameter D₍ₛ₎ₘₐₓ and the coercive force measured for each powder.

TABLE 4

| | Maximum particle | |
|---|---|---|
| | diameter D₍ₛ₎ₘₐₓ | |
| Example | (μm) | Coercive force (Oe) |
| 1 | 50 | 1180 |
| 2 | 50 | 1170 |
| 3 | 40 | 1300 |
| 4 | 40 | 1280 |
| 5 | 30 | 1360 |
| 6 | 20 | 1660 |
| 7 | 20 | 1850 |
| 11 | 1000 | 130 |
| 12 | 350 | 390 |

From Table 4, it is found that the maximum particle diameter D₍ₛ₎ₘₐₓ is 50 μm or less in the powders produced in Examples 1 to 7.

In addition, it is found that a high coercive force of 1,000 Oe or more is obtained in the powders produced in Examples 1 to 7.

### Aspects of Present Invention

The present invention may have the following aspects.

### Aspect 1

A method for producing magnetic particles containing a manganese-aluminum alloy, the method including:
mixing manganese particles, an aluminum source, an activator containing a halide, and an anti-sintering agent to obtain a mixed powder, in which the manganese particles have a maximum particle diameter of 50 μm or less, and the anti-sintering agent has a maximum particle diameter of 0.0002 times or more and 3 times or less the maximum particle diameter of the manganese particles;
heating the mixed powder to a temperature in a range of 1,000° C. to 1,235° C. to perform a calorizing treatment on the manganese particles to obtain a treated mixture that includes particles containing a manganese-aluminum alloy, in which the manganese-aluminum alloy has a ratio (Al/Mn) of aluminum to manganese in a range of 25/75 to 35/65 in mass ratio; and
collecting the particles containing a manganese-aluminum alloy from the treated mixture.

### Aspect 2

The method according to aspect 1, in which the collecting is performed using a magnetic separation method.

### Aspect 3

The method according to aspect 1 or 2, further including:
subjecting the mixed powder to a press treatment or a vibration treatment before performing the calorizing treatment on the manganese particles.

### Aspect 4

The method according to any one of aspects 1 to 3, in which the anti-sintering agent has an average particle diameter in a range of 0.01 μm to 150 μm.

### Aspect 5

The method according to any one of aspects 1 to 4, in which the anti-sintering agent has two or more particle size distribution peaks when a particle size distribution is measured.

### Aspect 6

The method according to any one of aspects 1 to 5, in which the anti-sintering agent has at least one shape selected from the group consisting of a spherical shape, a triangular pyramidal shape, a triangular prismatic shape, a tetrahedral shape, a conical shape, and a cylindrical shape.

### Aspect 7

The method according to any one of aspects 1 to 6, in which
the mixed powder is packed in a reaction vessel, and
the anti-sintering agent has a volume ratio in a range of 10% to 74% relative to a volume of the reaction vessel.

### Aspect 8

The method according to any one of aspects 1 to 7, in which
the mixed powder is packed in a reaction vessel, and
the mixed powder has a packing ratio in a range of 50% to 99% relative to a volume of the reaction vessel.

### Aspect 9

The method according to any one of aspects 1 to 8, in which the activator includes at least one selected from the group consisting of ammonium chloride, aluminum chloride, and aluminum fluoride.

### Aspect 10

The method according to any one of aspects 1 to 9, in which the activator is contained in a range of 0.1 mass % to 10 mass % relative to an entirety of the mixed powder.

### Aspect 11

The method according to any one of aspects 1 to 10, in which the manganese particles have an average particle diameter of 0.01 μm to 50 μm.

### Aspect 12

The method according to any one of aspects 1 to 11, in which the aluminum source has an average particle diameter of 0.1 μm to 300 μm.

### Aspect 13

The method according to any one of aspects 1 to 12, in which the calorizing treatment is performed in a pressurized environment.

### Aspect 14

The method according to aspect 13, in which the pressurized environment is achieved by introduction of an inert gas into a reaction vessel that is airtightly sealed.

### Aspect 15

The method according to aspect 13 or 14, in which the pressurized environment is achieved by a gas generated from the mixed powder packed in a reaction vessel that is airtightly sealed.

### Aspect 16

Magnetic particles including:
a manganese-aluminum alloy; and
alumina, in which
the alumina contained in the magnetic particles has an existence proportion in a range of 0.1 mass % to 30 mass %,
the manganese-aluminum alloy contained in the magnetic particles has an existence proportion in a range of 70 mass % to 99 mass %,
the manganese-aluminum alloy contains a τ phase,
the τ phase has an existence proportion in a range of 10 mass % to 99 mass % relative to the manganese-aluminum alloy, and
the magnetic particles have a maximum particle diameter of 50 μm or less and a coercive force of 1,000 Oe or more.

### Aspect 17

The magnetic particles according to aspect 16, in which the manganese-aluminum alloy further contains at least one selected from the group consisting of an ε phase, a β phase, and a γ phase.

### Aspect 18

The magnetic particles according to aspect 17, in which the manganese-aluminum alloy contains 10 mass % or less of the ε phase.

### Aspect 19

The magnetic particles according to any one of aspects 16 to 18, in which the manganese-aluminum alloy contains 65 mass % to 75 mass % of manganese and 25 mass % to 35 mass % of aluminum.

### Aspect 20

A MnAl-based permanent magnet containing:
the magnetic particles according to any one of aspects 16 to 19.

The present application claims priority based on Japanese Patent Application No. 2023-193429 filed on Nov. 14, 2023, and the entire contents thereof are incorporated herein by reference.

1. A method for producing magnetic particles containing a manganese-aluminum alloy, the method comprising:
mixing manganese particles, an aluminum source, an activator containing a halide, and an anti-sintering agent to obtain a mixed powder, wherein the manganese particles have a maximum particle diameter of 50 μm or less, and the anti-sintering agent has a maximum particle diameter of 0.0002 times or more and 3 times or less the maximum particle diameter of the manganese particles;
heating the mixed powder to a temperature in a range of 1,000° C. to 1,235° C. to perform a calorizing treatment on the manganese particles to obtain a treated mixture that comprises particles containing a manganese-aluminum alloy, wherein the manganese-aluminum alloy has a ratio (Al/Mn) of aluminum to manganese in a range of 25/75 to 35/65 in mass ratio; and
collecting the particles containing a manganese-aluminum alloy from the treated mixture.

2. The method according to claim 1, wherein the collecting is performed using a magnetic separation method.

3. The method according to claim 1, further comprising:
subjecting the mixed powder to a press treatment or a vibration treatment before performing the calorizing treatment on the manganese particles.

4. The method according to claim 1, wherein the anti-sintering agent has an average particle diameter in a range of 0.01 μm to 150 μm.

5. The method according to claim 1, wherein the anti-sintering agent has two or more particle size distribution peaks when a particle size distribution is measured.

6. The method according to claim 1, wherein the anti-sintering agent has at least one shape selected from the group consisting of a spherical shape, a triangular pyramidal shape, a triangular prismatic shape, a tetrahedral shape, a conical shape, and a cylindrical shape.

7. The method according to claim 1, wherein
the mixed powder is packed in a reaction vessel, and
the anti-sintering agent has a volume ratio in a range of 10% to 74% relative to a volume of the reaction vessel.

8. The method according to claim 1, wherein
the mixed powder is packed in a reaction vessel, and
the mixed powder has a packing ratio in a range of 50% to 99% relative to a volume of the reaction vessel.

9. The method according to claim 1, wherein the activator comprises at least one selected from the group consisting of ammonium chloride, aluminum chloride, and aluminum fluoride.

10. The method according to claim 1, wherein the activator is contained in a range of 0.1 mass % to 10 mass % relative to an entirety of the mixed powder.

11. The method according to claim 1, wherein the manganese particles have an average particle diameter of 0.01 μm to 50 μm.

12. The method according to claim 1, wherein the aluminum source has an average particle diameter of 0.1 μm to 300 μm.

13. The method according to claim 1, wherein the calorizing treatment is performed in a pressurized environment.

14. The method according to claim 13, wherein the pressurized environment is achieved by introduction of an inert gas into a reaction vessel that is airtightly sealed.

15. The method according to claim 13, wherein the pressurized environment is achieved by a gas generated from the mixed powder packed in a reaction vessel that is airtightly sealed.

16. Magnetic particles comprising:
a manganese-aluminum alloy; and
alumina, wherein
the alumina contained in the magnetic particles has an existence proportion in a range of 0.1 mass % to 30 mass %,
the manganese-aluminum alloy contained in the magnetic particles has an existence proportion in a range of 70 mass % to 99 mass %,
the manganese-aluminum alloy contains a τ phase,
the τ phase has an existence proportion in a range of 10 mass % to 99 mass % relative to the manganese-aluminum alloy, and
the magnetic particles have a maximum particle diameter of 50 μm or less and a coercive force of 1,000 Oe or more.

17. The magnetic particles according to claim 16, wherein the manganese-aluminum alloy further contains at least one selected from the group consisting of an ε phase, a β phase, and a γ phase.

18. The magnetic particles according to claim 17, wherein the manganese-aluminum alloy contains 10 mass % or less of the ε phase.

19. The magnetic particles according to claim 16, wherein the manganese-aluminum alloy contains 65 mass % to 75 mass % of manganese and 25 mass % to 35 mass % of aluminum.

20. A MnAl-based permanent magnet comprising:
the magnetic particles according to claim 16.
